(19) United States
(12) Patent Application Publication
(10) Pub. No.: US 2019/0262981 A1
(43) Pub. Date: Aug. 29, 2019

(54) SETTING TOOL

(71) Applicant: Hilti Aktiengesellschaft, Schaan (LI)

(72) Inventors: Markus SPRENGER, Mauren (LI); Peter ROTH, Grabs (CH); Peer SCHMIDT, Lindau (DE)

(21) Appl. No.: 16/307,705

(22) PCT Filed: Jul. 10, 2017
(86) PCT No.: PCT/EP2017/067289

§ 371 Date: Dec. 6, 2018

(30) Foreign Application Priority Data
Jul. 11, 2016 (EP) 16178770.0

(51) Int. Cl. B25C 7/00; B25C 1/08; B25F 5/02

(52) U.S. Cl. CPC B25C 7/00; B25C 1/008; B25F 5/02; B25C 1/08

(57) ABSTRACT

A setting tool for driving securing elements into a supporting surface, comprising a housing, a work machine arranged therein which generates a setting or percussive impulse, and a detection device for detecting the setting or percussive impulse. The detection device has an electronic processing unit, a sensor which generates an electric signal in the event of a setting or percussive impulse, a signal transmission device which transmits the electric signal from the sensor to the electronic processing unit, a battery which supplies electric energy to the electronic processing unit, and a printed circuit board at which the electronic processing unit, the sensor, and the battery are arranged. The invention is characterized in that the printed circuit board is provided with a potting compound which covers the electronic processing unit, the sensor, and the battery.

The present invention relates to a setting tool for driving securing elements into a supporting surface.

Such setting tools are usually operated with solid, gaseous or liquid fuels or also with pressurized or compressed air or electricity. With combustion-driven setting tools, a setting plunger is driven via the combustion gases, and can then be used to drive securing elements into a supporting surface. It is known that the settings of a setting tool can be detected with the aid of an acceleration sensor. The acceleration sensor is part of a detection device, which comprises other electronic components in addition to the acceleration sensor. Especially at high setting energies, high accelerations have an impact on the electronic components, which therefore loosen over time and may be damaged.

The object of the present invention is to provide a setting tool with a robust detection device.

The object is solved by a setting tool for driving securing elements into a supporting surface, comprising a housing, a work machine arranged therein which generates setting or percussive impulses and a detection device for detecting the setting or percussive impulses. The detection device has an electronic processing unit, a sensor generating an electric signal in the event of a setting or percussive impulse, a signal transmission device transmitting the electric signal from the sensor to the electronic processing unit, a battery supplying electric energy to the electronic processing unit, and a printed circuit board, wherein the electronic processing unit, the sensor, the battery and preferably the signal transmission device are arranged on the printed circuit board. The circuit board is provided with a potting compound covering the electronic processing unit, the sensor, the battery and, if necessary, the signal transmission device. Preferably, the potting compound completely covers the electronic processing unit, the sensor, the battery and, if necessary, the signal transmission device. By means of the potting compound, the elements covered or completely covered by it are held in position and may be mounted in a damped manner to cushion against high accelerations during the settings of the setting tool.

The signal transmission device transmits the electric signal from the sensor to the electronic processing unit, for example via a wired connection, comprising to this end a particularly cable-shaped signal line, or via a wireless connection, comprising to this end a transmitter and a receiver, operating in particular according to the Bluetooth low-energy or near-field communication standard.

An advantageous embodiment is characterized in that the sensor is configured as a unidirectional acceleration sensor. Preferably, the sensor comprises a piezo element for generating the electric signal when a setting or percussive impulse occurs. A switching threshold is particularly preferred, i.e. a threshold value for the acceleration from which a setting or percussive impulse is detected as such, adjustable by electronic means, particularly by the electronic processing unit.

Battery potting is in particular associated with the disadvantage that the battery cannot be replaced or can only be replaced with great effort. This is particularly the case if the battery is the only source of electricity of the setting tool intended to supply the detection device with electric energy, or if the battery comprises only one or more non-rechargeable primary cells and no rechargeable secondary cells. The detection device is therefore advantageously equipped with low-consumption components. Preferably, the detection device comprises an interface for data communication according to the Bluetooth low-energy standard. Also preferably, the detection device comprises an interface for data communication according to the RFID standard. Also preferably, the detection device comprises a passive, i.e. non-illuminating display. Also preferably, the detection device comprises an input element. Also preferably, the electronic processing unit comprises a microprocessor.

An advantageous embodiment is characterized in that the detection device comprises a memory intended to simultaneously store several different numbers of setting or percussive impulses. For example, the number of all settings, the number of remaining settings until a next cleaning and/or the number of remaining settings until a next maintenance are stored. Preferably, certain events, such as a reset of one of the setting numbers stated or the occurrence of an empty battery are detected, and particularly preferably stored in a diary integrated in the memory.

An advantageous embodiment is characterized in that the housing has a detachable assembly, in particular a cap, into which the detection device is inserted. Preferably, the detection device is attached only to the detachable assembly. The detachable assembly is then attached to the rest of the housing, for example, screwed tight to it.

An advantageous embodiment is characterized in that the battery comprises one or more non-rechargeable primary cells. A further advantageous embodiment is characterized in that the battery comprises one or more secondary cells, in particular, rechargeable via a wireless connection. The setting tool comprises for example a solar cell for charging the secondary cells.

Further advantages and measures of the invention result from the claims dependent thereon, the following description and the drawings. In the drawings the invention is shown in an exemplary embodiment.

The following applies:

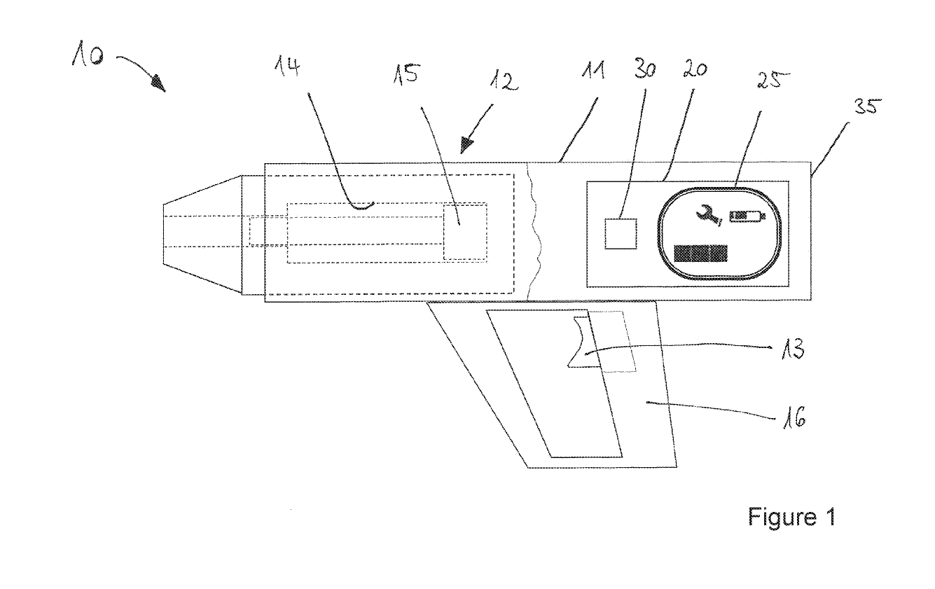

FIG. 1 schematically shows a setting tool in partial sectional view,

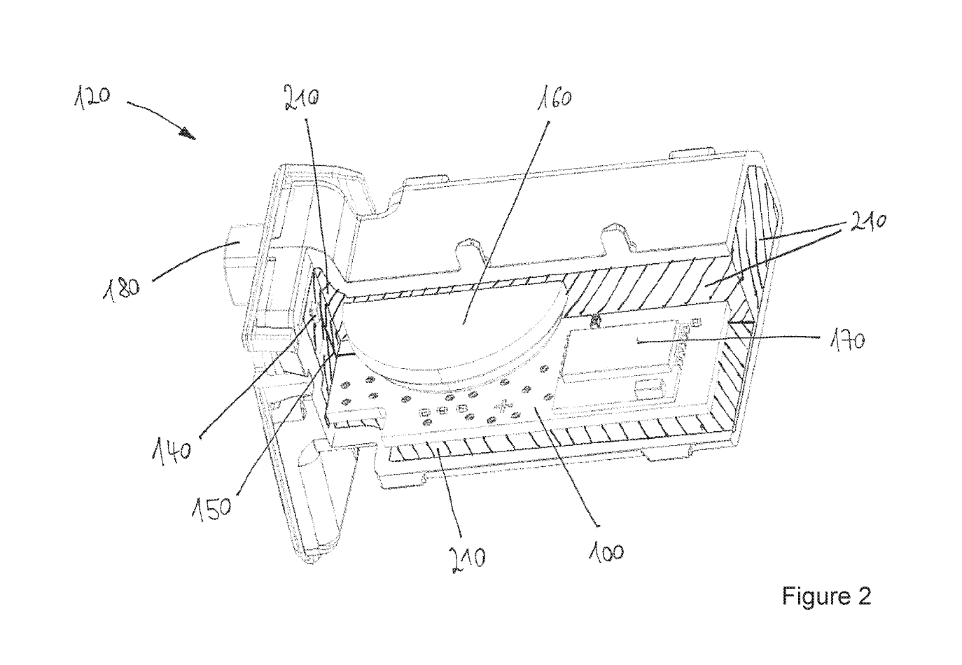

FIG. 2 shows a detection device in partial sectional view and

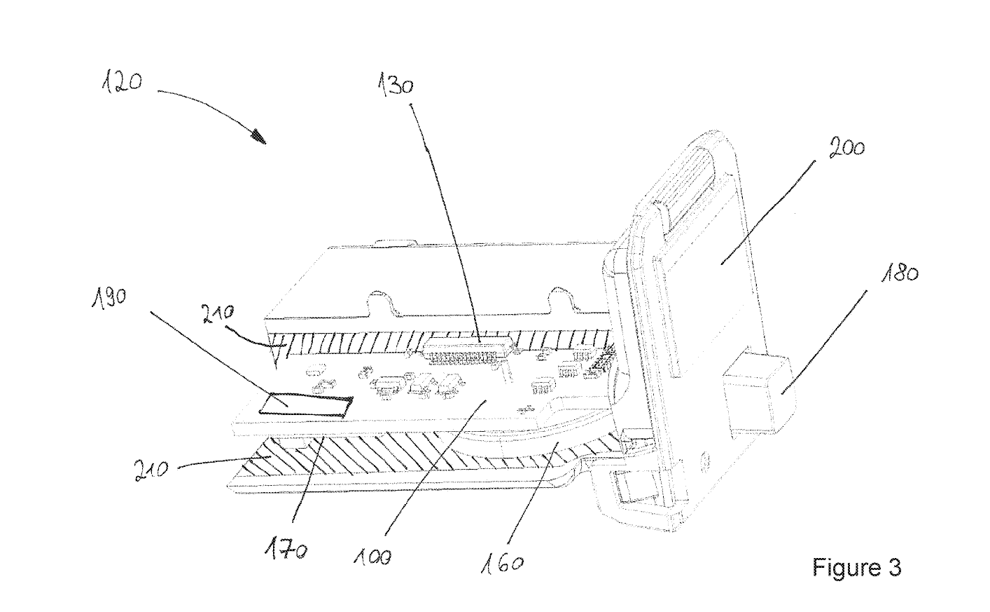

FIG. 3 shows the detection device from FIG. 2 in a further partial sectional view.

FIG. 1 shows a setting tool 10 in a partial sectional view. The setting tool 10 has a housing 11 and a work machine 12 which is arranged therein and is constructed as a striking machine comprising a piston 15 displaceably guided in a piston guide 14 and driven by means of a propellant, not shown here in a drawing, when a trigger switch 13, in particular a trigger switch 13 arranged on a handle part 16 of the setting tool 10, and optionally further safety switches are actuated. The piston 15 rushing forward in a setting process is used to drive a securing element located in front of the piston into a supporting surface.

During such a setting operation, a setting impulse acts in the setting tool 10, for the detection of which the setting tool 10 has a detection device 20 with a passive display 25 in the form of electronic paper and an input element 30 in the form of a push-button. The housing 11 has a detachable assembly 35 in the form of a cap in which the detection device 20 is inserted. The detection device 20 is only attached to the detachable assembly 35, for example screwed tight to it. The detachable assembly is itself attached to the rest of the housing 11, for example, screwed tight to it. This makes the detection device 20 together with the detachable assembly 35 easily exchangeable. The detachable module has a recess through which the display 25 is visible and the input element 30 can be reached.

In FIGS. 2 and 3, a detection device 120 is shown in a partial sectional view respectively from two different directions. The detection device 120 comprises a printed circuit board 100 onto which are fastened an electronic processing unit 130 formed as a microprocessor, a sensor 140 generating an electric signal upon the occurrence of a setting or percussive impulse, a signal transmission device 150 formed as a cable-shaped signal line transmitting the electric signal from the sensor 140 to the electronic processing unit 130, and a battery 160 supplying the electronic processing unit 130 with electric power.

The sensor 140 is configured as a unidirectional acceleration sensor and comprises a piezo element for generating the electric signal when a setting or percussive impulse occurs only in the setting direction. Accelerations in other directions, on the other hand, are not detected. The sensor 140 is arranged at a right-angled bent portion of the printed circuit board 100, whereby the printed circuit board 100 is particularly L-shaped or T-shaped, for example by means of flex prints. A switching threshold of the sensor 140 is set electronically by the electronic processing unit 130 via the signal transmission device 150. For example, four different switching thresholds are provided, namely one each for high, medium and low setting energies as well as for so-called empty settings, where there is no nail in front of the piston.

The detection device 120 is equipped with low-consumption components so that the battery 160 has a long lifetime. An interface 170 for data communication according to the Bluetooth low-energy standard, a rewritable passive RFID transponder 190 and a passive display 200 are fastened on the printed circuit board 100. Furthermore, the detection device 120 comprises an input element 180 configured as a push-button. The printed circuit board 100 is provided with a potting compound 210, which completely covers up the electronic processing unit 130, the sensor 140, the signal transmission device 150, the battery 160, the interface 170 and the RFID transponder 190. As a result, these elements are held in position and are also mounted in a damped manner to cushion against high accelerations.

The detection device further comprises 120 a memory integrated into the electronic processing unit 130, which is intended to simultaneously store the number of all settings, the number of remaining settings until a next cleaning and the number of remaining settings until a next maintenance. Preferably, certain events, such as a reset of one of the setting numbers stated or the occurrence of an empty battery are also detected and stored in a diary integrated in the memory. In particular, each detected setting is provided with a time stamp, for example with the aid of a real-time clock, and stored so that it is possible to trace when and how often the setting tool has been used by reading out the detected data.

The RFID transponder 190 is used to store the above-mentioned setting numbers as well as device data of the setting tool. Each time the input element 180 is actuated, the electronic processing unit 130 reads the device data from the RFID transponder 190 on the one hand and stores the current setting numbers from the memory integrated in the electronic processing unit 130 on the RFID transponder 190 on the other hand. It is therefore sufficient to store the device data only on the RFID transponder 190 during production. In addition, all data stored in the memory integrated into the 130 electronic processing unit will be stored on the RFID transponder 190 when the battery 160 charge level falls below a predetermined threshold so that the data will not be lost in the event of battery failure or when the input element 30 is actuated. The electronic processing unit 130 is awakened from a deep sleep mode by actuating the input element 30 or at predetermined intervals by means of a real-time clock to update the display 25 to subsequently return to the deep sleep mode.

The stored data include, for example, a maximum number of settings each for cleaning and maintenance, the time of the last cleaning, the time of the last maintenance, a state of charge of the battery, the presence of an error and, if applicable, an error code, one or more time stamps, a current operating mode, the number of supported operating modes and the like.

In addition, when the input element 180 is actuated, the interface 170 is activated so that the electronic processing unit 130 can contact a remote terminal via radio. This enables the remote terminal to identify and monitor the setting tool, preferably several setting tools. In particular, the remote terminal can be used to track the use of the setting tools and to plan with regard to cleaning and maintenance. This makes it possible to reduce downtimes. It is also possible to control the consumption of consumables and order supplies in a timely manner.

The display 200 transmits a wide range of information to a user, such as the battery 160 charge level, detected in particular by voltage measurement, the total number of settings carried out by the setting tool, the number of settings remaining until the next maintenance, the number of settings remaining until the next cleaning or information as to whether the 170 interface is active. The number of settings remaining until the next maintenance can only be reset to zero in a meaningful way by maintenance personnel, whereas the number of settings remaining until the next cleaning operation can be reset by each user whilst cleaning the setting tool.

The detection device is advantageously fastened to a frame, which in part mechanically transmits percussive impulses past the detection device, so that all accelerations (harmful and to be detected) have only a reduced effect on the detection device and thus also on the acceleration sensor. This provides mechanical protection for the detection device, whereby the switching threshold of the acceleration sensor is adapted accordingly.

1. A setting tool for driving securing elements into a supporting surface, the tool comprising a housing, a work machine arranged therein generating setting or percussive impulses and a detection device for detecting the setting or percussive impulses, wherein the detection device comprises an electronic processing unit, a sensor generating an electric signal when a setting or percussive impulse occurs, a signal transmission device transmitting the electric signal from the sensor to the electronic processing unit, a battery supplying the electronic processing unit with electric power, and a printed circuit board on which the electronic processing unit, the sensor and the battery are arranged, wherein the printed circuit board is provided with a potting compound covering the electronic processing unit, the sensor and the battery.

2. The setting tool according to claim 1, wherein the potting compound completely covers the electronic processing unit, the sensor and the battery.

3. The setting tool according to claim 1, wherein the potting compound covers the signal transmission device.

4. The setting tool according to claim 1, wherein the sensor is configured as a unidirectional acceleration sensor.

5. The setting tool according to claim 1, wherein the sensor comprises a piezo element for generating the electric signal upon occurrence of the setting or percussive impulse.

6. The setting tool according to claim 1, wherein the detection device comprises one or more interfaces for data communication according to a Bluetooth low-energy standard.

7. The setting tool according to claim 1, wherein the detection device comprises one or more interfaces for data communication according to an RFID standard.

8. The setting tool according to claim 1, wherein the detection device comprises a passive display.

9. The setting tool according to claim 1, wherein the detection device comprises an input element.

10. The setting tool according to claim 1, wherein the electronic processing unit comprises one or more microprocessors and/or memories.

11. The setting tool according to claim 1, wherein the detection device comprises a memory intended to simultaneously store several different numbers of setting or percussive impulses.

12. The setting tool according to claim 1, wherein the housing comprises a separable assembly into which the detection device is inserted.

13. The setting tool according to claim 1, wherein the battery is the only electric power source of the setting tool which is provided for supplying the detection device.

14. The setting tool according to claim 1, wherein the battery comprises one or more non-rechargeable primary cells.

15. The setting tool according to claim 1, wherein the battery comprises one or more rechargeable secondary cells.

16. The setting tool according to claim 3, wherein the potting compound completely covers the signal transmission device, and wherein the signal transmission device is arranged on the printed circuit board.

17. The setting tool according to claim 2, wherein the potting compound covers the signal transmission device.

18. The setting tool according to claim 2, wherein the sensor is configured as a unidirectional acceleration sensor.

19. The setting tool according to claim 2, wherein the sensor comprises a piezo element for generating the electric signal upon occurrence of the setting or percussive impulse.

20. The setting tool according to claim 2, wherein the detection device comprises one or more interfaces for data communication according to a Bluetooth low-energy standard.
